(19) United States
(12) Patent Application Publication
(10) Pub. No.: US 2016/0194515 A1
(43) Pub. Date: Jul. 7, 2016

(54) POLYMER COMPOSITES WITH UV SHIELDING STRENGTH

(71) Applicant: AGENCY FOR SCIENCE, TECHNOLOGY AND RESEARCH, Singapore (SG)

(72) Inventors: Xu LI, Singapore (SG); Yu Yuan CHIENG, Singapore (SG); Siew Yee WONG, Singapore (SG); Shilin CHEN, Singapore (SG); Changliang REN, Singapore (SG)

(21) Appl. No.: 14/910,628

(22) PCT Filed: Aug. 7, 2014
(86) PCT No.: PCT/SG2014/000377

§ 371 Date: Feb. 5, 2016

(30) Foreign Application Priority Data
Aug. 7, 2013 (SG) 2013060124

(51) Int. Cl. C09D 133/02; C09D 129/04

(52) U.S. Cl. CPC C09D 133/02; C09D 129/04; C08K 9/02

(57) ABSTRACT

There is provided an aqueous composite coating solution comprising a polymer matrix, a metal oxide immobilized onto an inorganic filler and optionally an additional UV absorber. The coating solution can be used to prepare barrier coatings shielding the substrate from UV radiation, moisture and oxygen. There is also provided a process for making such aqueous using titanium dioxide immobilized on clay in the composite materials. Protective layers obtained from coating using the composite polymer solutions are also provided.

### TECHNICAL FIELD

The present invention generally relates to a composite coating solution comprising metal oxides immobilized on inorganic fillers besides a polymer matrix. The present invention also relates to the use of said, solutions for making UV protective layers on plastic films useful in the packaging industries.

### BACKGROUND

Plastic films such as Biaxially Oriented Polypropylene (BOPP) and Polyethylene terephthalate (PET) have attracted much attention as food packaging materials due to their advantages such as strength and stiffness, transparency and flexibility. While these polymer materials have good mechanical properties and moldability, their barrier performance against oxygen and moisture are relatively poor. Also, there remains a need for the development of an improved polymer packaging with good ultraviolet light shielding properties. For packing applications oxygen and moisture (relative humidity) will significantly influence the quality of the produce packaged. The presence of oxygen and moisture in food packages will accelerate the spoilage of food and encourage rapid mold growth. On the other hand, ultraviolet light is a major cause of photo-oxidation of photo sensitive products during storage and transportation. Nevertheless, common transparent plastic films that are available for food packaging are poor UV-barriers. The BOPP and PET films may be improved by coatings with layers containing polymer composites.

Polymer composites have recently been developed mainly to improve the mechanical properties and barrier performance of polymers to moisture and gases such as oxygen and carbon dioxide. Polymer composites are mixtures of polymers with inorganic or organic fillers with certain geometries. U.S. Pat. No. 6,358,576 B1, US 2012/0308761A1 and US 2013/0071672A1 disclose such approaches. The obtainable coatings are however not satisfying for all applications, especially with regard to UV protection.

Metal oxides, such as titanium dioxide (TiO₂) are considered as UV-absorbing materials in food packaging. However, one of the biggest problems in the application of metal oxides for food packaging is the non-homogeneous dispersion and instability of particles in the matrix, because metal oxides have a strong tendency to agglomerate and are difficult to recover due to their large surface areas.

Other works have been reported on the development of further UV barrier films. Such compositions comprise organic substances and polymers with other additives. U.S. Pat. No. 5,629,365A discloses such UV-absorbing polymer latex coatings containing homopolymers and copolymers of vinyl-functionalized monomer of benzotriazole or benzophenone. Further, U.S. Pat. No. 6,855,435B2 discloses a process for making a transparent, UV-stabilized thin film. The film comprises of 0.01 to 5% by weight of UV stabilizer from benzophenone and benzotriazoles groups and 10-50,000 ppm of optical brightener such as triazine-phenylcoumarin. U.S. Pat. No. 8,052,900B2 discloses a coating solution comprising a reactive UV absorber, diluents and a curing catalyst. The reactive UV absorber comprises a mixture of a benzophenone derivative having hydroxyl and alkoxysilyl groups and a benzophenone derivative having silyloxy and alkoxysilyl groups.

As known, organic compounds such as benzotriazoles and benzophenones are efficient of absorbing UV radiation in the wavelength range from 300 to 400 nm. Meanwhile, metal oxides such as TiO₂ and ZnO are efficient to stop UV rays in a wavelength range between 200 to 320 nm. Therefore, the combination of both compounds was said to be efficient to stop the UV rays with wavelength range 200 to 400 nm. EP 1004626A1 discloses an extruded thin packaging film made out of a thermoplastic material, low density polyethylene (LDPE), in combination with one organic compound preferably benzotriazole and one inorganic compound, preferably zinc oxide or titanium oxide, and also a binder compound benzophenone. U.S. Pat. No. 8,088,848B2 discloses a process of making a transparent polypropylene film comprising 0.1 to 5% by weight of metal oxides (ZnO and TiO₂) and <2% by weight of organic materials (benzotriazole and benzophenone). The film was prepared by compounding UV barrier additives in the powder state with polypropylene pellets using a twin screw extruder. However, these inventions are not fully satisfying as they present a difficulty to obtain uniform dispersion of metal oxides within the polymer matrix. Further, a major disadvantage of the use of polar organic UV absorbers such as benzotriazoles and benzophenone is their poor stability and the observed migration effects that lead to a greasy film surface and loss of UV barrier property over time. Hence, there is still a need to find alternatives to make protective polymer layers that cover a broad UV absorption range.

### SUMMARY

According to a first aspect, there is provided a composite coating solution comprising a polymer matrix, a metal oxide immobilized onto an inorganic filler and optionally an additional UV absorber.

Advantageously, the disclosed coating solution may be useful to produce coatings on a plastic film wherein the metal oxide filler is distributed uniformly and which provide UV shielding and are a good barrier against oxygen and moisture uptake.

Further advantageously, the above coatings may display a broad UV shielding when an additional UV absorber is added as an additive.

According to a second aspect, there is provided a process for making a coating solution according the first aspect comprising the following steps
a) immobilizing of a metal oxide and optionally a UV absorber onto an inorganic filler, and
b) blending the obtained composites with the polymer matrix.

According to a third aspect, there is a provided the use of the coating solution of the first aspect to produce a layer on the surface of a plastic film by coating.

According to a fourth aspect, there is provided a polymer composite layer obtained by coating the surface of a plastic film with a coating solution according to the first aspect.

According to a fifth aspect, there is provided a plastic film comprising a layer according to the fourth aspect with a thickness of about 0.1 to 5 μm.

Advantageously, the plastic films with the inventive layer are showing an improved UV shielding activity combined with moisture and oxygen protection for all materials covered with the plastic film. Advantageously, the inventive barrier layer reduces the water vapor transmission rate of plastic films to about 50%, and show an optimum oxygen transmission rate of less than 0.50 cc/[m²·day]. Further advantageously, at the point of UV light transmittance between 200 and 360 nm, the film transmits less than 20% of the UV light incident upon the film at the said wavelength transmittance. Plastic films protected in this way are ideally suited for packaging applications where such capabilities are desirable.

According to a sixth aspect, there is provided a plastic film according to the fifth aspect which additionally comprises an adhesive layer of a thickness of about 0.1 to 5 μm coated on at least one of the surfaces of the plastic film.

According to a seventh aspect there is provided a coating solution according to the first aspect for making food and beverage packaging, UV protective layers for textiles, outdoor and window coverings, paint compositions or for preparing cosmetic and topical pharmaceutical compositions.

### DEFINITIONS

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

Unless the context requires otherwise or specifically stated to the contrary, integers, steps, or elements of the invention recited herein as singular integers, steps or elements clearly encompass both singular and plural forms of the recited integers, steps or elements.

As used herein, unless otherwise specified, the following terms have the following meanings, and unless otherwise specified, the definitions of each term apply when that term is used individually or as a component of another term (e.g., the definition of aryl is the same for aryl and for the aryl portion of arylalkyl, alkylaryl, arylalkynyl, and the like).

As used herein, the term “composite” or “polymer composite” refers to mixtures of polymers with inorganic fillers with certain geometries.

As used herein, the term “inorganic fillers” refers to inorganic materials that can be formally defined with reference to that they are not organic matter.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, 2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DESCRIPTION OF THE DISCLOSURE

In one aspect, there is provided a composite coating solution comprising a polymer matrix, a metal oxide immobilized onto an inorganic filler and optionally an additional UV absorber. The composition may be used to generate a polymer layer as a coating.

The composite coating solution can be an aqueous (water-based) and gelatinous coating solution, but is not limited thereto. Aqueous means that the solution is water-based in the meaning that it contains preferably more than 30% of water, most preferably more than 50% water and most preferably more than 80% water.

According to a preferred embodiment the polymer matrix, can be used in a concentration of about 0.5 to 20% by weight of the total coating solution, preferably about 0.5 to 10% and most preferred about 1 to 5%. The polymer matrix may be comprised of a polymer that has at least a hydroxyl functional group and a carboxyl functional group and mixtures thereof. In one embodiment, the polymer having a hydroxyl functional group may be selected from the group consisting of polyvinyl alcohol polymer and its derivatives. The polymer having a carboxyl functional group may be selected from the group consisting of polycarboxylic acid and its derivatives such as polyacrylic acid polymer. The polymer matrix comprises preferably a mixture of a polymer that has at least a hydroxyl functional group and polymer that has a carboxyl functional group for an optimum reinforcement. The amount of polymer in the polymer composite layer produced with the inventive coating solution according to the first aspect may be in the range of 20 to 80% by weight, based on the weight of inorganic filler, such as clay, more preferably in the range of 50 to 60% by weight.

The metal oxide can be any metal oxide which has at least a low ability to absorb UV light and includes for instance particles of titanium dioxide (TiO₂), zinc oxide (ZnO) and iron oxide (Fe₂O₂). The weight ratio of metal oxide to inorganic filler can be varied widely. A weight ratio of metal oxide to inorganic filler, especially clay, of 4:1 to 1:75 is preferred. Other suitable ranges include 3:1 to 1:50; 1:1 to 1:25 and 1:1 to 1:10. TiO₂ is particularly preferred as metal oxide. According to a preferred embodiment the metal oxide, especially titanium dioxide, can be used in a concentration of about 0.01 to 10% by weight of the total coating solution, preferably 0.05 to 5% and most preferred 0.1 to 3%. The average diameter of the metal oxide particles is preferably within the range of 1 to 500 nm, more preferably within the range of 3 to 300 nm and even more preferably within the range of 5 to 100 nm. According to the invention, it has been found, that the TiO₂ preferably is used in specific form. For achieving an especially good UV shielding it can be used in the rutile phase and anatase phase or mixtures thereof. It has been found that TiO₂ that is about 70 to 100% in the rutile phase and about 0 to 30% in anatase phase shows especially high UV shielding. It has also been found that TiO₂ in the rutile phase is the most stable phase with nanorod structure (approximately 20×100 nm), which has excellent properties as UV blocker combined with chemical inertness, good thermal stability, high density, high refractive index and superior light scattering characteristics. On the other hand, small spherical TiO₂ anatase phases with a particle size of approximately 6 nm (Scherrer's formula) are more photocatalytically active than rutile. According to the invention, the weight fraction of rutile and anatase phases can be controlled by varying the volume or concentration of the acid solution used during the synthesis process.

According one embodiment of the invention, titanium dioxide nanoparticles were immobilized onto the clay sheets as shown in FIG. 1b and FIG. 2c. TiO₂ and clay interaction via cation exchange or electrostatic interaction, a reaction which occurs very rapidly, can be ascribed to the formation of strong composites. Some embodiments of the invention make use of the finding that montmorillonite (MMT) carries a negative charge, which attracts the positively charged titanium dioxide nanoparticles that are prepared at pH value of 1 to 2. The TiO₂ particles are then intercalated within the clay sheets. The presence of an impurity compound has decreased the MMT peak intensity at 7° as shown in the figures. It is evidence that addition of TiO₂ nanoparticles has dramatically increased the viscosity of MMT from 3-4 cP Newtonian suspension to about 400 to 500 cP at 20 s⁻¹ with a shear thinning fluid behavior.

The UV absorber may be a filler that has the ability to absorb UV light. According to a preferred embodiment, the UV absorber, especially carbon particles, can be used in a concentration of about 0.001 to 5% by weight of the total coating solution, preferably about 0.005 to 3% and most preferred about 0.01 to 2%. It can be immobilized on the inorganic filler (e.g. clay) together with the metal oxide. Carbon particles are particularly preferred according to the invention as the additional UV absorber. The carbon particles in the present invention can be particles synthesized of furfuryl alcohol and/or glucose via hydrothermal treatment. Carbon particles useful in the invention can be made according to known methods, but may be preferably made via hydrothermal treatment of organic compounds, e.g. at 200° C. for 18 hours. The average diameter of the carbon particles is preferably within the range of about 1 to 500 nm, more preferably within the range of about 3 to 300 nm and even more preferably within the range of about 5 to 100 nm. The carbon particles are preferably first added into a suspension of the inorganic filler, e.g. clay, and then followed by addition of metal oxide, e.g. titanium dioxide, suspension. Carbon particles may form binding forces when dispersed onto clay sheets and strongly interact with TiO₂ nanoparticles as depicted in FIGS. 3c and 3d. The significant decreases of MMT XRD peak intensity (FIGS. 4b and 4c) at 7° and broadening of peak at 29° proved the strong interaction and intercalation of carbon and TiO₂ nanoparticles within the MMT sheets. In a preferred embodiment, the presence of carbon particles has substantially enhanced the dynamic viscosity of the TiO₂-clay composites solution from 400-500 to 1000-2000 cP at 20 s⁻¹. TiO₂-clay/carbon composites may then be heated at 80° C. for 6-8 hours under stirring to improve the bonding between particles.

In one embodiment of the invention the absorber is not an optional component, but a mandatory one. Coating solutions according to such embodiment show an especially broad wavelength range of UV shielding. They show the inventively improved dispersion of the inorganic filler with the immobilized metal oxide combined with the UV absorber.

In one embodiment of the invention the inorganic filler is a clay material. According to a preferred embodiment the clay material, can be used in a concentration of about 0.5 to 20% by weight of the total coating solution, preferably about 0.5 to 10% and most preferred about 1 to 5%. The clay of this clay material can be selected from of montmorillonite, bentonite, laponite, kaolinite, saponite, vermiculite and mixtures thereof. The clay may be natural clay, synthetic clay or silane(s) treated clay. In one embodiment, the clay material is montmorillonite. According to the invention any clay with a plate-like structure and high aspect ratio may be especially suitable. The ratio of clay material to polymer matrix may be widely chosen, but is preferably between about 10 to 100%, more preferred about 20 to 80% and most preferred about 40 to 50% by weight. Advantageously, this embodiment allows achieving a homogenous dispersion of a high concentration of clay sheets in the polymer matrix. The clay sheets are well-oriented along the polymer matrix and will not significantly affect the optical properties of any coating prepared from the coating solution.

In a preferred embodiment the clay material has been pretreated with a silane coupling agent. The silane coupling agent can be a single silane or a mixture of several silanes. Amino silanes and glycidoxy silanes are particularly preferred silanes in this embodiment. Such silanes are for example commercially available from Aldrich. Silanes which may be especially mentioned include (3-glycidoxypropyl)trimethoxysilane, (3-glycidoxypropyl)triethoxysilane, (3-aminopropyl)trimethoxysilane, (3-aminopropyl)triethoxysilane and mixtures thereof. Silanes which are particularly preferred, especially for MMT, include (3-glycidoxypropyl)trimethoxysilane, (3-aminopropyl)trimethoxysilane and mixtures thereof. In case of the mixture the two silanes can be mixed in a wide range, preferably the concentration ratio in the mixture of (3-aminopropyl)trimethoxysilane and (3-glycidoxypropyl)trimethoxysilane is between about 1:4 to 1:1, more preferably between about 1:4 to about 4:5. Most preferably the concentration ratio is about 2:3. The silanation of the inorganic filler/clay can be performed according to known methods or as substantially described in the working examples. The clay sheets are usually pretreated with silane coupling agents in a mixture containing about 0.5 to 10% by weight, preferably 1 to 5% by weight, of the silane coupling agent

According to the invention it has been found that a pretreatment of the clay in an admixture of a silane coupling agent may significantly improve the clay dispersion into the polymer matrix. Suitable silane coupling agents are those that support bonding by providing crosslinking abilities. For instance an alkoxy reactive group of the silane can bind to the clay silicate and an epoxy reactive group may be made available for binding to the polymer in the polymer matrix. Addition of amino silanes to glycidoxy silanes is an embodiment of the invention to further improve the composite strength and adhesion to the polymer. Additionally, it has been found that the hydroxyl groups of metal oxides may also form covalent bonding with alkoxy groups of silane in the coating solution improving binding to the clay silicates, or the polymer matrix. Surprisingly, it has been found that the silane coupling agents can significantly improve the interfacial interaction between the clay sheets, metal oxides and the polymer matrix to form strong composite materials suitable in the inventive coatings.

Yet more embodiments of the first aspect of the invention include:

A coating solution comprising about 0.1 to 3% of titanium dioxide as the metal oxide, 1 to 5% of optionally silane pretreated clay as the inorganic filler, 1 to 5% of the polymer matrix, 85 to 97.9% of water and optionally 0.01 to 2% of carbon particles as UV absorber (all weight %). Another coating solution comprising about 0.5 to 2% of titanium dioxide as the metal oxide, 2 to 4% of optionally silane pretreated clay as the inorganic filler, 2 to 4% of the polymer matrix, 85 to 97.9% of water and optionally 0.1 to 1 of carbon particles as UV absorber (all weight %).

Yet another embodiment is an aqueous, gelatinous coating solution according to the first aspect of the invention comprising a combination of titanium dioxide as the metal oxide immobilized onto optionally silane pretreated clay and optionally carbon particles as additional UV absorber, a polymer matrix containing poly(vinyl alcohol) and poly (acrylic acid) polymers and water.

The coating solution according to these further embodiments show highly preferred capabilities of UV shielding combined with moisture and oxygen barrier capabilities.

According to a second aspect, there is provided a process for making a coating solution according the first aspect comprising the following steps
a) immobilizing of a metal oxide and optionally a UV absorber onto an inorganic filler, and
b) blending the obtained composites with the polymer matrix.

The process can be used to prepare a barrier layer on a plastic film.

The immobilization can be performed by dropwise addition of nanoparticles of carbon particles and metal oxide into a suspension of inorganic filler. The immobilization can be performed at various temperatures, but ambient temperatures (about 20 to 30° C.) are preferred. The solvent of the suspension is not critical, but water or an aqueous solvent mixture are preferred.

The obtained composites can then be blended under stirring with the polymer matrix components, such as for instance poly(vinyl alcohol) and poly (acrylic acid) polymer solutions. The blending can be performed at various temperatures, but ambient temperatures (about 20 to 30° C.) are preferred. The solvent of the suspension is not critical, but water or an aqueous solvent mixture are preferred.

In another embodiment the process is used for the preparation of a water-based coating solution comprising the steps of
a) immobilizing of titanium dioxide and optionally the carbon particles onto clay sheets, and
b) blending the obtained composites with the poly(vinyl alcohol) and poly (acrylic acid) polymers in a homogeneous mixture.

The clay sheets for immobilization of TiO₂ and the carbon particles can preferably be MMT sheets or silane pre-treated MMT sheets.

According to a third aspect, there is a provided the use of the coating solution of the first aspect to produce a layer on the surface of a plastic film by coating. The plastic films can consist of any polymer material. Polyethylene terephthalate (PET) and biaxially oriented polypropylene films (BOPP) used in packaging applications may be selected as the plastic films to be coated with the layer.

The metal oxide-inorganic filler/UV absorber/polymer composite suspension made according to the invention is then applied onto a surface of a plastic film.

According to a fourth aspect, there is provided a polymer composite layer obtained by coating the surface of a plastic film with a coating solution according to the first aspect.

The layer has a barrier effect. To achieve best possible barrier characteristics the polymer composite layer may be of a thickness of several μm, preferably about 0.1 to 5 μm or most preferred less than 2 μm. Preferably the layer is coated on the surface of the plastic film. The amount of clay in the barrier layer may be in the range of about 20 to 80% by weight, based on the weight of polymer matrix, and more preferably in the range of about 30 to 60% by weight, and particular preferably in the range of 40 to 50% by weight.

According to a fifth aspect, there is therefore provided a plastic film comprising a layer according to the fourth aspect with a thickness of about 0.1 to 5 μm. The layer can be on the outside surface of the plastic film or can be a layer inside the plastic film. The outside layer can be applied by typical coating techniques. The internal inventive layer can be for instance obtained by laminating a plastic film covered with adhesive layer (preferable of a thickness 0.1 to 5 μm) with a plastic film where the inventive layer according to the fourth aspect is already coated on the outside as described in the following paragraphs to obtain the final plastic film with three layer structure (e.g. plastic/(TiO₂-clay/carbon/polymer composite)plastic).

The final two or three layer plastic film finally contains between about 0.5 to 30% by weight, preferably 1 to 5%, of the metal oxide/inorganic filler/UV absorber/polymer matrix components. This weight percentage can be calculated by measuring the weight change of a part of the inventive coating solution before and after drying. Especially preferred is a coated plastic film which contains between about 1 to 10 preferably 4 to 6%, and most preferred about 5% by weight of TiO₂/clay/carbon/polymer composite components.

The coating of plastic films with the composite coating solution can be done via blade coating using a film applicator to form a composites layer thereon. A bilayer structure of (metal oxide-inorganic filler/UV absorber/polymer composite)/plastic is obtained. The inorganic filler such as clay sheets may be homogeneously dispersed in the said polymer composites and aligned along the substrate plane by employing the shearing force during the application. The applied polymer composites layer on the plastic film substrate can then be dried by air flash at room temperature. A heating step is then preferably followed by vacuum drying at about 40° C. to 60° C. (most preferably about 50° C.).

In another embodiment another plastic film substrate may be coated with adhesive as binder to improve the adhesion between two plastic films. The applied said adhesive/plastic bilayer is dried by air flash at room temperature.

In one embodiment, a heating step can be undertaken when a (metal oxide-inorganic filler/UV absorber/polymer composite)/plastic film bilayer film is compressed together with said adhesive/plastic film to form a plastic/(metal oxide-inorganic filler/UV absorber/polymer composite)/plastic trilayer film.

The temperature used during the heating step may be in the range of 100 to 140° C. depending on the plastic substrate used. In one embodiment, the temperature applied is about 105° C. for biaxially oriented polypropylene substrate and is about 130° C. for polyethylene terephthalate substrate. The heating step May be a laminating step. It is preferable to apply pressure during the lamination process. In one embodiment the coating solution is accordingly used for producing a laminated plastic film comprising the inventive composites and an adhesive.

As a result a plastic film comprising a layer according to the fourth aspect with a thickness of about 0.1 to 5 μm which additionally comprises an adhesive layer coated on at least one of the surfaces of the plastic film is obtained. To achieve best possible adhesive characteristics the additional adhesive layer may be of a thickness of several μm, preferably about 0.1 to 5 μm and most preferred less than 2 μm. It can be coated on top of the first coated layer by lamination or can be coated on the other surface by lamination.

According to a sixth aspect, there is therefore provided a plastic film according to the fifth aspect which additionally comprises an adhesive layer of a thickness of about 0.1 to 5 μm coated on at least one of the surfaces of the plastic film.

The laminated metal oxide-inorganic filler/UV absorber/polymer composite)/plastic trilayer film of an embodiment of the produced layer allows light to pass through the film. The presence of TiO₂ and carbon particles in the composite layer that contained inside in the middle layer of plastic films, may substantially shield the ultraviolet light from 200 to 400 nm, with a maximum UV light blockage at 200 to 360 nm (see FIGS. 5 and 6). In one embodiment, TiO₂ nanoparticles were immobilized onto clay sheets and homogeneously dispersed within the polymer matrix, retaining high transparency of film after coating. Addition of carbon particles in the present invention can substantially increase the UV shielding property of TiO₂-clay/polymer composites without causing significant reduction in the film transparency. Its translucent appearance may find many potential applications in paint and coating industry. According to the invention it has been found that the concentration of composites and the thickness of the composites layer have a huge impact on the transmission properties of the film. Process optimization to produce a thin composites layer with a thickness of less than 5 μm, preferably a thickness which is below 1 μm is desirable for uses in packaging, as such requires a lower amounts of chemicals, low thickness film and excellent transparency.

Especially the TiO₂-clay/carbon/polymer composites coated plastic films showed good oxygen and water vapor barrier properties as demonstrated in Table 1 and Table 2, respectively. The thickness of the TiO₂-clay/carbon/polymer composites layer may be about 0.1 to 5 μm; while the thickness of final plastic films is range from 10 to 20 μm. Table 1 showed the oxygen transmission rates measured at 23° C. at a 0% RH for a number of test films. The oxygen transmission rates of composites layer coated plastic films were significantly reduced in comparison to that of pure plastic film. The presence of carbon particles in the composites layer had not only enhanced the UV shielding property, but also improved the barrier property of film against oxygen. Silanes treated clay composites layer has further reduced the oxygen permeation rates through the films. The lowest OTR of the composites/plastic films were measured as 0.40 and 1.44 cc/(m²·day) for PET and BOPP film, respectively. Meanwhile, Table 2 showed the water vapor transmission rates measured at 37.8° C. at a 90% RH for a number of test films. The water vapor transmission rates of composites layer coated plastic films were reduced to about 50% in comparison to that of pure plastic film.

TABLE 1
Oxygen Transmission Rates of Films

| Type of Film* | OTR (cc/[m² · day]) |
|---|---|
| PET | 187.27 |
| (TiO₂-clay/polymer)/PET | 0.74 |
| (TiO₂-clay/CNI/polymer)/PET | 0.48 |
| (TiO₂-clay/CNII/polymer)/PET | 0.65 |
| (TiO₂-modified | 0.40 |
| clay/CNI/polymer)/PET | |
| BOPP | 2650.87 |
| (TiO₂-clay/polymer)/BOPP | 2.30 |
| (TiO₂-clay/CNI/polymer)/BOPP | 1.69 |
| (TiO₂-clay/CNII/polymer)/BOPP | 2.22 |
| (TiO₂-modified | 1.44 |
| clay/CNI/polymer)/BOPP | |

*Thickness of the composite layer was controlled at about 5 μm

TABLE 2
Water Vapor Transmission Rates of Films

| Type of Film* | WVTR (gm/[m² · day]) |
|---|---|
| PET | 56.83 |
| (TiO₂-clay/polymer)/PET | 21.98 |
| (TiO₂-clay/CNI/polymer)/PET | 20.62 |
| (TiO₂-clay/CNII/polymer)/PET | 25.95 |
| (TiO₂-modified | 25.67 |
| clay/CNI/polymer)/PET | |
| BOPP | 7.67 |
| (TiO₂-clay/polymer)/BOPP | 3.67 |
| (TiO₂-clay/CNI/polymer)/BOPP | 3.82 |
| (TiO₂-clay/CNII/polymer)/BOPP | 3.96 |
| (TiO₂-modified | 4.77 |
| clay/CNI/polymer)/BOPP | |

*Thickness of the composite layer was controlled at about 5 μm

According to the invention it has been therefore further found that, due to the presence of composites as a barrier layer coated on the plastic film, the final plastic film substantially inhibits the permeation of gases and water vapor molecules to pass through the film. According to the invention the hierarchically structure of clay sheets with immobilized metal oxide and carbon particles may create a longer tortuous path for molecules diffusion, thus reduce the permeation rate of gas and water vapor molecules. The film in the present invention has a potential for packaging applications. Hence, the low permeation rate of oxygen and water vapor through the plastic film can substantially protect the contents of the package from oxidation and deterioration. Furthermore, the designed packaging film is flexible to contour according to a variety of packaged materials and applications. Advantageously the inventive plastic films are transparent/translucent while being efficient to completely shield the transmittance of UV B and UV C radiation between 100 to 315 nm and partially shield UV A radiation up to 360 nm.

According to a seventh aspect there is therefore provided a coating solution according to the first aspect of the invention for making food and beverage packaging, UV protective layers for textiles, outdoor and window coverings, paint compositions or for preparing cosmetic and topical pharmaceutical compositions.

Other aspects and embodiments of the invention include:
1) A composites coating solution comprising at least a first and a second additives for improving UV shielding property of the coated plastic film.
2) A composition according to 1), wherein said first additive comprises 0.1-3.0 wt % of titanium dioxide.
3) A composition according to 2), wherein said titanium dioxide has a particle size from 5-100 nm.
4) A composition according to 2), wherein said titanium dioxide can be in rutile form, or mixture of rutile and anatase, or in anatase form.
5) A composition according to 4), wherein said TiO₂ in rutile and anatase form with a weight fraction of 70-100% and 30-0%, respectively, is good for UV shielding property.
6) A composition according to 1), wherein said second additive comprises less than 2.0 wt % of carbon particles.
7) A composition according to 6), wherein said carbon particle has a particle size from 5-100 nm.
8) A composition according to 6), wherein said carbon particles were synthesized from furfuryl alcohol (CNI).
9) A method according to 8), wherein said CNI was prepared via hydrothermal treatment at 200° C. for 18 hours.
10) A process for the preparation of TiO₂-clay/carbon/polymer composites water-based coating solution which comprises the steps of (1) immobilization of TiO₂ and carbon particles onto the clay or silanes treated clay sheets (2) a blend of said composites homogeneously mix with poly(acrylic acid) and poly(vinyl alcohol) polymers.
11) A composition according to 10), wherein said clay is montmorillonite and silanes treated montmorillonite with concentration 1-5 wt %.
12) A composition according to 11), wherein said silanes treated montmorillonite, comprising silicate chemically coupled to a polymer matrix by a mixture of silane coupling agents.
13) A composition according to 12), wherein said silane coupling agents are (3-aminopropyl)trimethoxysilane and (3-glycidoxypropyl)trimethoxysilane at a concentration ratio of 2:3.
14) A composition according to 10), wherein said composites comprising from about 20-80% by weight clay with additives homogeneously dispersed in from about 20-80% by weight of a polymer.
15) A method of producing a composites film, comprising a TiO₂-clay/carbon/polymer barrier layer according to 10), coated on inner surface thereof of a plastic film, wherein said barrier layer has a thickness ranging from about 0.5-5 μm.
16) The composites film according to 15) further comprising an adhesive layer coated on at least one surface of plastic film, wherein said adhesive layer has a thickness ranging from about 0.5-5 μm.
17) The composites film according to 15), wherein the barrier layer reduces the water vapor transmission rate of plastic films to about 50%, and with the optimum oxygen transmission rate of <0.50 cc/[m2·day].
18) The composites film according to 15) and 16), wherein at the point of UV light transmittance between 200 and 360 nm, the film transmits about <20% of the UV light incident upon the film at the said wavelength transmittance.

### BRIEF DESCRIPTION OF DRAWINGS

The accompanying drawings illustrate a disclosed embodiment and serve to explain the principles of the disclosed embodiment. It is to be understood, however, that the drawings are designed for purposes of illustration only, and not as a definition of the limits of the invention.

FIG. 1 shows TEM images of (a) TiO₂ nanoparticles and (b) TiO₂ immobilized onto MMT sheets.

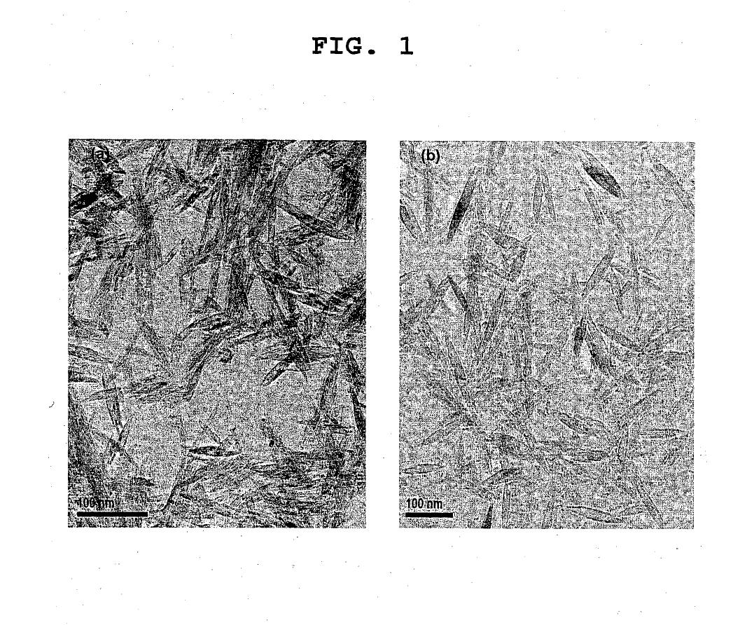

FIG. 2 shows the structure characteristics of (a) MMT; (b) TiO₂ and (c) MMT-TiO₂ composites.

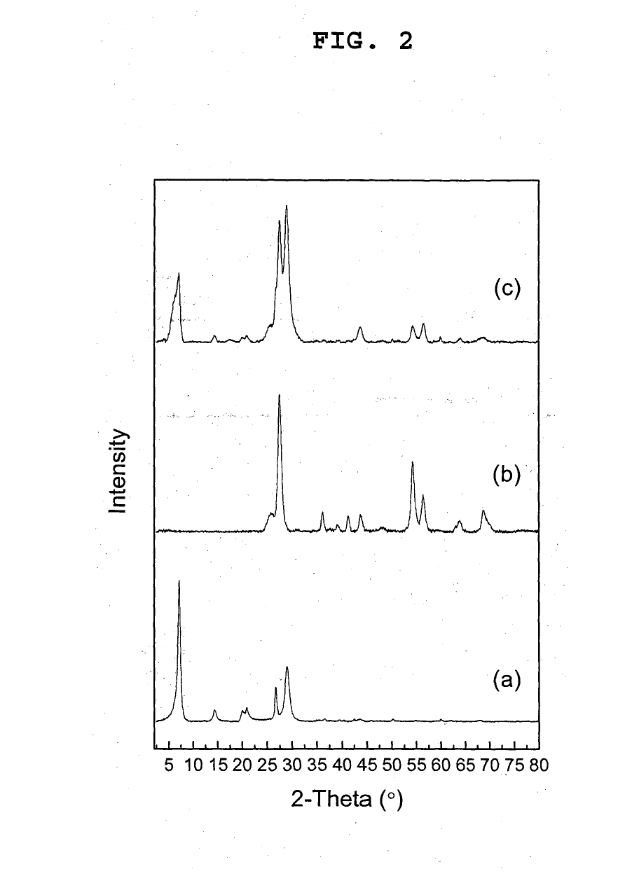

FIG. 3 shows TEM images of carbon particles (a) CNI; (b) CNII and it's mixture with MMT-TiO₂ composites (c) MMT TiO₂/CNI and (d) MMT-TiO₂/CNII.

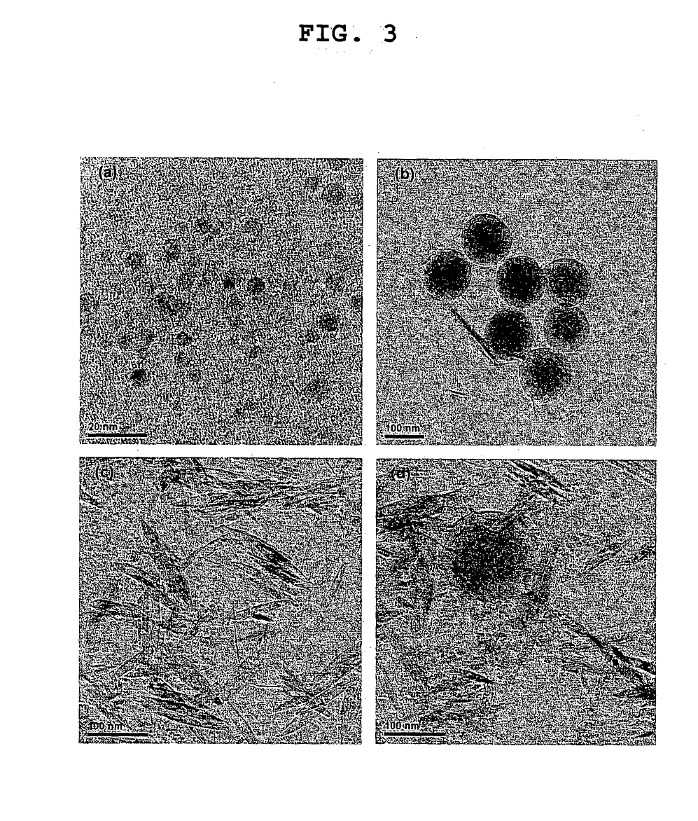

FIG. 4 shows the structure characteristics of (a) MMT-TiO₂; (b) MMT-TiO₂/CNI and (c) MMT-TiO₂/CNII.

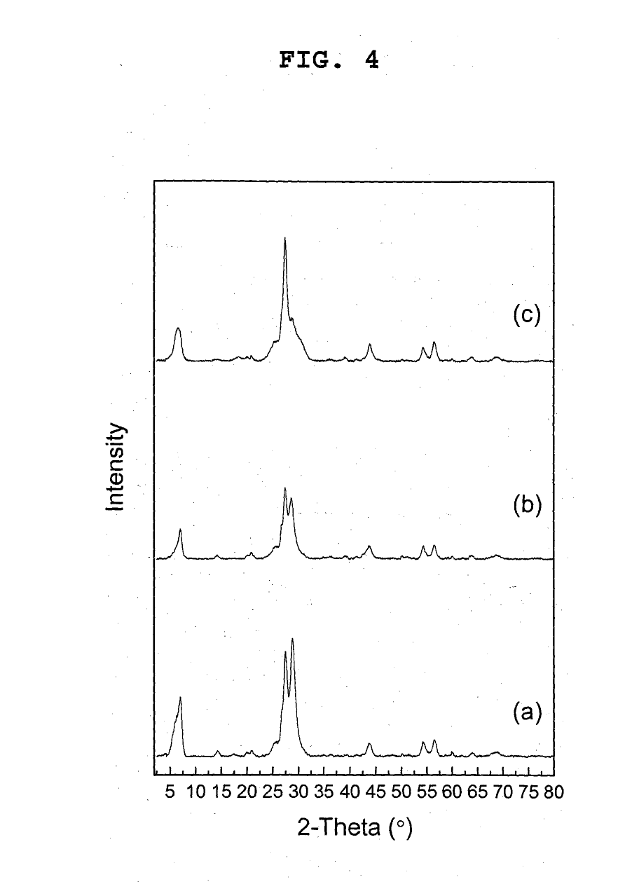

FIG. 5 shows UV spectra of laminated

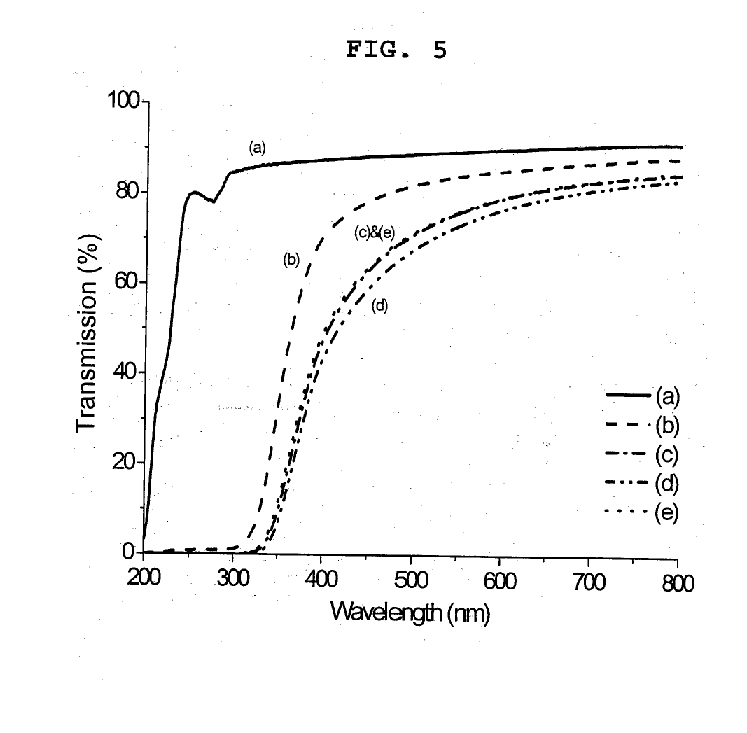

(a) BOPP/BOPP;

(b) BOPP/(MMT-TiO₂/Polymers)/BOPP;

(c) BOPP/(MMT-TiO₂/CNI/Polymers)/BOPP;

(d) BOPP/(MMT-TiO₂/CNII/Polymers)/BOPP and

(e) BOPP/(Modified MMT-TiO₂/CNI/Polymers)/BOPP films.

FIG. 6 shows UV spectra of laminated

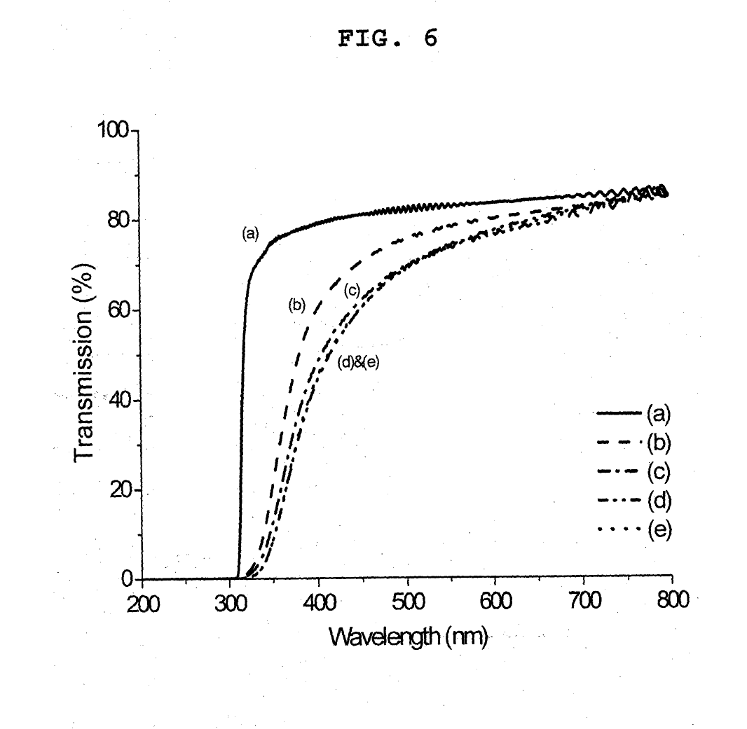

(a) PET/PET;

(b) PET/(MMT-TiO₂/polymers)/PET;

(c) PET/(MMT-TiO₂/CNI/Polymers)/PET;

(d) PET/(MMT-TiO₂/CNII/Polymers)/PET and

(e) PET/(Modified MMT-TiO₂/CNI/Polymers)/PET films.

### EXAMPLES

Synthesis/Preparation examples and non-limiting examples of the invention will be further described in greater detail by reference to specific Examples, which should not be construed as in any way limiting the scope of the invention.

### Synthesis Example 1

### Synthesis of Titanium Dioxide (TiO₂)

Titanium dioxide nanoparticles were prepared via soft gel method by using a facile soft chemical process. First, 9 ml of titanium (IV) isopropoxide (97%, Aldrich) were dissolved in 66 ml of absolute ethanol. The solution was then added dropwise by using a dropping funnel into 90 ml of deionized water under vigorous magnetic stirring. After complete addition, the suspension was stirred at room temperature for 1 hour and then heated at 80° C. for 3 to 6 hours under stirring. Then, 300 ml of 1 M NaOH was added, and the mixture was continuously stirred at 70° C. for 12 hours. The TiO₂ nanoparticles were collected by centrifugation at 7000 rpm for 5 minutes, and thoroughly washed with deionized water for 5 times. Subsequently, for each 1.125 ml of titanium (IV) isopropoxide used, 20 ml of 1 M HNO₃ was added as a peptization reagent, and the mixture was continuously stirred at 70° C. for 4 hours. All the heating processes were undertaken in airproof condition. Finally, the TiO₂ nanoparticles were separated from the acidic medium by centrifugation at 9000 rpm for 15 minutes. The obtained TiO₂ nanoparticles could be easily dispersed in deionized water (5 ml) to form a colloid suspension.

### Synthesis Example 2

### Synthesis of Carbon Particles I (CNI)

45 μL of furfuryl alcohol Fluka) was dissolved in 30 ml of deionized water to form a clear solution. The solution was sonicated for 2-5 minutes to completely dissolve the furfuryl alcohol. Then, the solution was transferred into a Teflon-lined stainless-steel autoclave (40 ml in capacity). The autoclave was heated at 200° C. for 18 hours, and then allowed to cool to room temperature. The CNI solution was collected for use.

### Synthesis Example 2b

### Synthesis of Carbon Particles II (CNII)

3.0 g of D(+)(−)Glucose (>99.5%, Sigma Aldrich) was dissolved in 30 ml of deionized water to form a clear solution. Then, the solution was transferred into a Teflon-lined stainless-steel autoclave (40 ml in capacity). The autoclave was heated at 180° C. for 3 hours, and then allowed to cool to room temperature. The CNII particles were obtained by centrifugation at 9000 rpm for 30 minutes. The particles were then washed with deionized water and absolute ethanol for 3 times, respectively, by centrifugation at 9000 rpm for 10 minutes each. CNII obtained was re-dispersed in deionized water for use.

### Preparation Example 1

### Preparation of Clay Suspension (MMT)

2.0 g of pristine clay (montmorillonite) obtained from Nanocor Inc. of Arlington Heights of Illinois of the United States of America was mixed with 100 ml deionized water and stirred for 3 hours followed by ultrasonication in a water-bath for 30 minutes. The solution was further stirred overnight to obtain clay suspension in water.

### Preparation Example 1b

### Preparation of Modified Clay Suspension (Modified MMT)

1.0 g of pristine clay (montmorillonite) obtained from Nanocor Inc. of Arlington Heights of Illinois of the United States of America was mixed with 60 ml deionized water and stirred for 3 hours followed by ultrasonication in a water-bath for 30 minutes. Then, 0.09 ml of acetic acid was added to the solution and stirred for another 24 hours. To exchange water with acetone, acetone was added to the suspension to a total volume of 600 ml. The mixture was then homogenized using an IKA T18 Basic Ultra Turrax for 5 minutes at 14,000 rpm. Thereafter, the slurry precipitate was filtered with a Buchner funnel and washed with acetone. The collected slurry precipitate was re-suspended into 600 ml of acetone and homogenized for 5 minutes at 14,000 rpm followed by filtration and washing. The washing process was repeated for another two times to get clay suspension in acetone. The slurry precipitate was transferred to a 250 ml, round bottom flask. 0.02 g of (3-aminopropyl)trimethoxysilane (97%, Aldrich) and 0.03 g of (3-glycidoxypropyl)trimethoxysilane (≧98%, Aldrich) were added (5 wt % of clay). After stirring for 3 hours at room temperature (about 25° C.), the mixture was ultrasonicated for 30 minutes and stirred overnight at 50° C.

### Preparation Example 2

### Preparation of Poly(Vinyl Alcohol) (PVA) Solution

5.0 g of PVA (1000 completely hydrolyzed obtained from Wako Chemicals USA, Inc of Richmond, Va. of the United States of America) was dissolved in 50 ml of deionized water under stirring at 100° C.

### Preparation Example 3

### Preparation of Poly(Acrylic Acid) (PAA) Solution

5.0 g of PAA (MW 450,000 obtained from Polysciences, Inc. of Warrington, Pa. of the United States of America) was dissolved in 50 ml of deionized water under stirring at room temperature (about 25° C.).

### Preparation Example 4

### Preparation of TiO₂—Clay/Polymer Composites

Titanium dioxide nanoparticles suspension obtained from Synthesis. Example 1 was added dropwise into MMT or Modified MMT suspension obtained from Preparation Example and Preparation Example 1b. The mixture was then physically mixed under magnetic stirring at room temperature for 8 hours. PVA and PAA polymer solutions obtained from Preparation Examples 2 and 3 were added to the MMT-TiO₂ or Modified MMT-TiO₂ suspension. The mixture was then homogenized using an IKA T18 Basic Ultra Turrax for 15-30 minutes at 14,000 rpm.

### Inventive Example 5

### Preparation of TiO₂-Clay/Carbon/Polymer Composites

Carbon particles (CNI or CNII) obtained from Synthesis Example 2 or Synthesis Example 2b were added dropwise into MMT or Modified MMT suspension. The mixture was magnetically stirred for 6 hours at room temperature. TiO₂ nanoparticles suspension from Synthesis Example 1 was then added dropwise into the mixture solution. The mixture was further magnetically stirred for 8 hours at ° C. PVA and PAA polymer solutions obtained from Preparation Examples 2 and 3 were then added to the MMT-TiO₂-CNI/CNII or Modified MMT-TiO₂-CNI/CNII suspension. The mixture was then homogenized using an IKA T18 Basic Ultra Turrax for 15-30 minutes at 14,000 rpm.

### Inventive Example 6

### Preparation of TiO₂-Clay/Carbon/Polymer Composites Film

TiO₂-clay/carbon/polymer composites coating solution obtained from Example 5 were blade coated onto a PET or BOPP film by using a film applicator with an applicator bar coating gap controlled at 50 or 100 μm. Another plastic film was coated with adhesive. The applied composites and adhesive layers were then dried by air flash at room temperature overnight. Both of the coated plastic films were compressed together by using a laminator at 105° C. and 130° C. for BOPP and PET films, respectively.

### Testing Examples

### Test Methods

### Transmission Electron Microscope (TEM)

TEM observation was performed with a high-resolution transmission electron microscope (Philips CM300 FEGTEM) under an acceleration voltage of 300 kV. One drop of the sample suspension was diluted with deionized water and placed on a 200-mesh carbon coated copper grid and dried in air at room temperature before observation.

### UV-Visible Transmission

UV-visible transmission of the laminated pure plastic films and plastic/(composites)/plastic films were measured using Shimadzu UV-2501PC, UV-Vis Recording Spectrophotometer. The measurement was conducted by using air as reference at room temperature in the range of 200 to 800 nm.

### X-Ray Diffraction

The structure characteristic and crystalline phase of composites was evaluated by X-Ray Diffraction (XRD) analysis. It was performed by using a Bruker D8 General Area Detector Diffraction System (GADDS) XRD using Cukα radiation (k=0.154 nm) with a scanning angle ranging from 2 to 80°.

### Oxygen Transmission Rate

Oxygen permeability of composites coated BOPP or PET film was measured by using Mocon oxygen permeability OX-TRAN Model 2/21 according to ASTM D3985. Each film was placed on a stainless steel mask with an open testing area of 5 cm². Oxygen permeability measurements were conducted at 23° C. (1 atm) and 0% relative humidity by placing coated surface of films to the oxygen rich side.

### Water Vapor Transmission Rate

Water vapor permeability of composites coated BOPP or PET film was measured by using Mocon water vapor permeability PERMATRAN-W Model 3/33 according to ASTM F1249. Each film was placed on a stainless steel mask with an open testing′ area of 5 cm². Water vapor permeability′ measurements were conducted at 37.8° C. (1 atm) and 90% relative humidity by placing coated surface of films to the water vapor rich side.

Test results of the testing examples are shown in the figures.

### APPLICATIONS

The disclosed aqueous composite coating solution comprises a polymer matrix, a metal oxide immobilized onto an inorganic filler and optionally an additional UV absorber.

Advantageously, the coating solution can be used to generate protective layers that exhibit broad protective capabilities against UV radiation.

Therefore advantageously, the disclosed coating solution has many uses in applications where barriers against UV radiation and moisture uptake are needed.

Such application areas include food and beverage packaging, UV protective layers for textiles, outdoor and window coverings, paint compositions as well as cosmetic and topical pharmaceutical compositions.

Further advantageously, the layers produced with the coating solution can be used on plastic films to protect materials from deterioration and oxidation, if for instance being applied in packaging. The plastic films with the barrier layers according to the invention are still transparent/translucent in their appearance which is highly desirable in the industry sectors concerned.

It will be apparent that various other, modifications and adaptations of the invention will be apparent to the person skilled in the art after reading the foregoing disclosure without departing from the spirit and scope of the invention and it is intended that all such modifications and adaptations come within the scope of the appended claims.

1-23. (canceled)

24. A composite coating solution comprising a polymer matrix, a metal oxide immobilized onto clay sheets and optionally an additional UV absorber.

25. The coating solution according to claim 24 wherein the clay sheets have been pretreated with a silane coupling agent.

26. The coating solution according to claim 24 wherein the metal oxide is titanium dioxide.

27. The coating solution according to claim 26 wherein the titanium dioxide is of a particle size of about 5 to 100 nm.

28. The coating solution according to claim 26 wherein the titanium dioxide is 70 to 100% in the rutile phase and 0 to 30% in anatase phase.

29. The coating solution according to claim 26 wherein the titanium dioxide is used in a concentration of about 0.1 to 3% by weight of the total solution.

30. The coating solution according to claim 24 wherein the additional UV absorber is present and a carbon particle is used as the UV absorber.

31. The coating solution according to claim 30 wherein the carbon particle is of a particle size of about 5 to 100 nm.

32. The coating solution according to claim 30 wherein the carbon particles are used in a concentration of about 0.01 to 2% by weight of the total solution.

33. The coating solution according to claim 24 wherein the polymers of polymer matrix are selected from poly(vinyl alcohol), poly(acrylic acid) and mixtures thereof.

34. The coating solution according to claim 24 wherein the concentration of the polymer matrix is about 1 to 5% of the solution.

35. The coating solution according to claim 24 comprising about 0.1 to 3% of titanium dioxide as the metal oxide, 1 to 5% of optionally silane pretreated clay sheets, 1 to 5% of the polymer matrix, 85 to 97.9% of water and optionally 0.01 to 2% of carbon particles as UV absorber.

36. The coating solution according to claim 24 comprising titanium dioxide as the metal oxide immobilized onto optionally silane pretreated clay sheets and optionally carbon particles as additional UV absorber, a polymer matrix containing poly(vinyl alcohol) and poly (acrylic acid) polymers and water.

37. A process for making a coating solution comprising a polymer matrix, a metal oxide immobilized onto clay sheets and optionally an additional UV absorber comprising:
a) immobilizing of a metal oxide and optionally a UV absorber onto clay sheets, and
b) blending the obtained composites with the polymer matrix.

38. The process for making a coating solution according to claim 37 comprising:
a) immobilizing of titanium dioxide and optionally the carbon particles onto clay sheets, and
b) blending the obtained composites with the poly(vinyl alcohol) and poly (acrylic acid) polymers in a homogeneous mixture.

39. The process according to claim 37 wherein the clay sheets are pretreated with silane coupling agents in a mixture containing about 1 to 5% of by weight of the silane coupling agent.

40. The process according to claim 39 wherein the clay is montmorillonite and the silane coupling agents are used as a mixture of (3-aminopropyl)trimethoxysilane and (3-glycidoxypropyl)trimethoxysilane in a mixing range of about 1:5 to 4:5.

41. Use of a coating solution comprising a polymer matrix, a metal oxide immobilized onto clay sheets and optionally an additional UV absorber to produce a layer on the surface of a plastic film by coating.

42. A polymer composite layer obtained by coating the surface of a plastic film with a coating solution comprising a polymer matrix, a metal oxide immobilized onto clay sheets and optionally an additional UV absorber.

43. A plastic film comprising a layer obtained by coating the surface of a plastic film with a coating solution comprising a polymer matrix, a metal oxide immobilized onto clay sheets and optionally an additional UV absorber with a thickness of about 0.1 to 5 μm.

44. The plastic film according to claim 43 which additionally comprises an adhesive layer of a thickness of about 0.1 to 5 μm coated on at least one of the surfaces of the plastic film.
